(19) United States
(12) Patent Application Publication
(10) Pub. No.: US 2007/0032291 A1
(43) Pub. Date: Feb. 8, 2007

(54) Method of playing a slot machine using paylines of varying numbers of symbol positions

(75) Inventors: Daniel Mordecai Marks, Cold Spring, NY (US); Anthony Mark Singer, Ringwood, NJ (US); Howard Mitchell Marks, Scardale, NY (US)

Correspondence Address: PTT LLC (D/B/A HIGH 5 GAMES), 1200 MACARTHUR BLVD, MAHWAH, NJ, 07430, US

(73) Assignee: High 5 Games, Nanuet, NY (US)

(21) Appl. No.: 11/499,438

(22) Filed: Aug. 4, 2006

Related U.S. Application Data
(60) Provisional application No. 60/705,372, filed on Aug. 4, 2005.

(51) Int. Cl. A63F 13/00

(52) U.S. Cl. 463/20

(57) ABSTRACT

The present invention includes a variety of methods to issue awards based upon “short” and/or “long” pay lines. In general, short pay lines fewer positions than the conventional pay lines; long pay lines use more positions than conventional pay lines. In particular, games using conventional, horizontal pay lines may also use short pay lines with fewer positions, or long pay lines more positions, than the number of columns; and games using conventional, vertical pay lines also use short pay lines with fewer positions, or long pay lines more positions, than the number of rows.

### PRIORITY CLAIM

This application is a non-provisional patent application that claims priority to and the benefit of U.S. Provisional Patent Application Ser. No. 60/705,372, filed Aug. 4, 2005, incorporated herein by reference.

### COPYRIGHT NOTICE

A portion of the disclosure of this patent document contains or may contain material subject to copyright protection. The copyright owner has no objection to the photocopy reproduction of the patent document or the patent disclosure in exactly the form it appears in the Patent and Trademark Office patent file or records, but otherwise reserves all copyright rights.

### FIELD OF THE INVENTION

In general, the present invention relates to slot machine awards and, more particularly, to new forms of pay lines and pay line awards.

### BACKGROUND OF THE INVENTION

To play a conventional slot machine, the player deposits money into the machine, sets the wager, spins the reels, and collects credits for winning combinations, if any, according to a pay schedule. Since conventional slot machines are limited to the foregoing methods, players, casino operators, and game manufacturers suffer from the following disadvantages:

Players grow bored of playing games using same method of play;

Casinos suffer from player dissatisfaction with the casino's game selection;

Casinos cannot distinguish their games from other casinos; and

Game manufacturers cannot distinguish their products from other manufacturers.

Slot manufacturers and casino operators develop new methods to overcome these limitations. One method includes multiple pay lines, such as 9, 15, or 20 pay lines. With multiple pay lines, players may enjoy increased win frequency; casinos may increase coins played per spin; and game manufacturers may offer a variety of games using any number of pay lines.

In known games using multiple pay lines, each pay line may be defined horizontally and/or vertically. Horizontal pay lines include exactly one position in each of the columns (“conventional horizontal” pay lines); vertical pay lines include exactly one position in each of the rows (“conventional vertical” pay lines). For example, a conventional horizontal pay line includes exactly five positions across a 3-row by 5-column symbol matrix.

No known games use pay lines with fewer positions (“short” pay lines) or more positions (“long” pay lines) than the conventional pay lines. In particular, no known game using conventional, horizontal pay lines also uses pay lines with fewer positions or more positions than the number of columns; and no known games using conventional, vertical pay lines also uses pay lines with fewer positions or more positions than the number of rows. The full potential for slot machine pay outs, therefore, remains unrealized.

### SUMMARY OF THE INVENTION

The present invention includes a variety of methods to issue awards based upon the appearance of symbols in short and/or long pay lines.

A first preferred embodiment of the present invention uses nine conventional, horizontal pay lines and one short pay line in a 3-row by 5-column symbol matrix. The short pay line uses three positions in three columns—middle position of the first, third, and fifth columns—with a distinctive border placed around each of the positions. Short pay line awards issue for three same symbols appearing in the three short pay line positions.

A second preferred embodiment of the present invention uses nine conventional, horizontal pay lines and one long pay line in a 3-row by 5-column symbol matrix. The long pay line uses eight positions in three columns—all positions in the second, third, and fourth columns, except for the middle position of the third column—with a distinctive border placed around each of the positions. Long pay line awards issue for three or more same symbols appearing anywhere in the eight long pay line positions.

Thus, the present invention uses short and long pay lines to issue new and exciting awards without duplicating any of the conventional pay line awards.

### BRIEF DESCRIPTION OF THE DRAWINGS

The present invention, including the preferred embodiments, may be best understood in reference to the accompanying figures:

FIG. 1 shows a representative screen display of three “E” symbols appearing in the three positions of a three position short pay line.

FIG. 2 shows a representative screen display of four “C” symbols appearing in four positions of an eight position long pay line.

### DETAILED DESCRIPTION OF THE INVENTION

To play the preferred embodiments, the player initializes credits, sets the wager, spins the reels, and collects credits for short pay and/or long pay line awards:

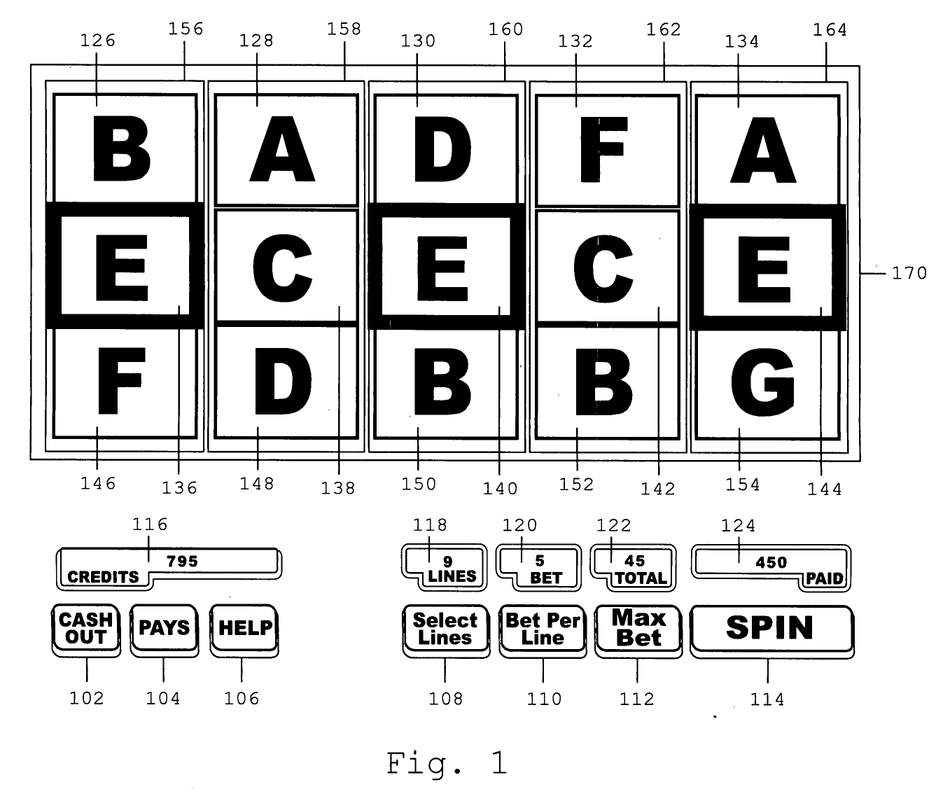

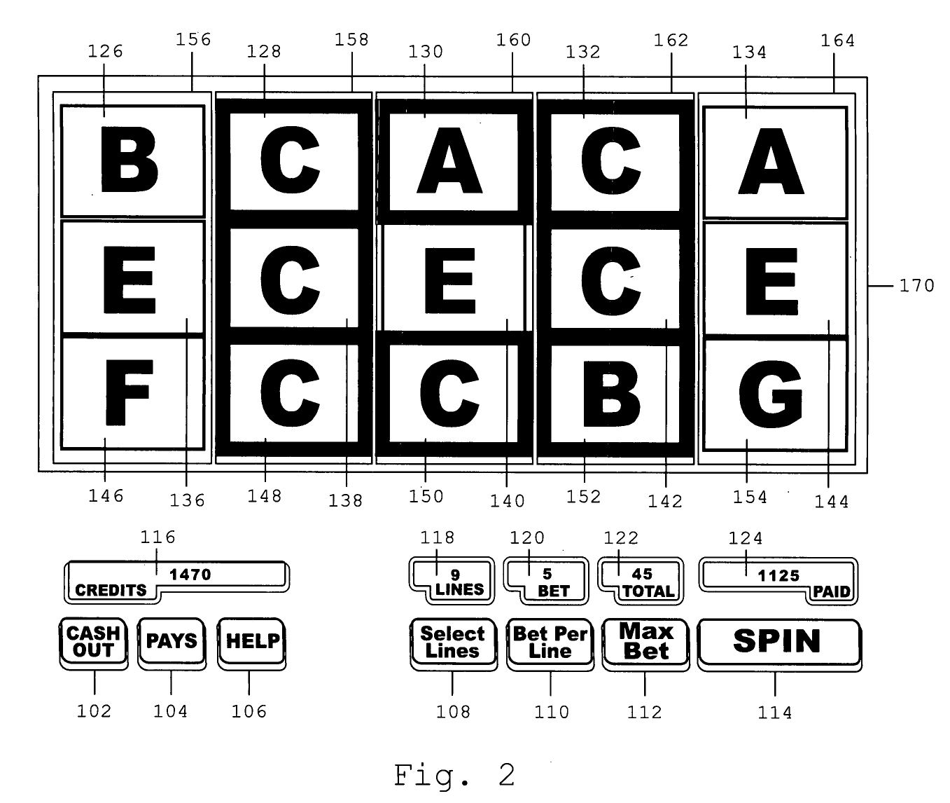

Initialize Credits. In FIGS. 1 and 2, the player initializes credits by depositing money in the form of coins, gaming tokens or paper currency into a coin head (not shown) or bill acceptor (not shown). Coins and gaming tokens are collected in a reservoir (not shown) inside the gaming machine; paper currency is collected in the bill acceptor (not shown) inside the gaming machine. If the coins, gaming tokens or paper currency are validated as authentic, the player accrues the appropriate number of playing credits on the Credit meter 116. More credits may be initialized, if necessary, by additional deposits of coins, tokens or paper currency. Alternatively, any method of initializing credits may be used including debit cards, credit cards, smart cards, or other form of electronic finds transfer.

Set the Wager. In FIGS. 1 and 2, the player sets the wager by selecting conventional pay lines and setting the bet per conventional pay line. The wager is calculated by multiplying the number of selected conventional pay lines by the bet per conventional pay line. For example, the player may wager five credits on each of nine conventional pay lines for a total bet of forty-five credits. The total bet amount is displayed on the Total Bet meter 122.

To select conventional pay lines, the player uses the Select Pay Lines button 108 and views the number of selected conventional pay lines on the Select Pay Lines meter 118. Conventional pay lines are selected in a predetermined order. For example, the first conventional pay line selected is always pay line 1, second conventional pay line selected is always pay line 2, etc. Players do not select short or long pay lines, as these pay lines are always selected.

To set the bet per conventional pay line, the player uses the Bet Per Pay Line button 110 and views the amount bet per conventional pay line on the Bet Per Pay Line meter 120. The same amount is wagered on each conventional pay line. For example, up to five credits may be wagered on each conventional pay line. Players do not set the bet per short or long pay lines, as these pay lines are always wagered upon.

In addition to the Select Lines 108 and Bet Per Line 110 buttons, the player may use the Bet Max button 112 to place the maximum bet per conventional pay line on all conventional pay lines. The Bet Max button 112 only selects conventional pay lines and sets the wager for conventional pay lines. The Bet Max button 112 does not select any short or long pay lines or set the amount bet on these pay lines.

Short and/or long pay lines are always selected and wagered upon by the slot machine. An algorithm sets the bet per short and/or long pay line as a function of the total bet. For example, 10 percent of the total bet may be assigned to the short and/or long pay lines.

Spin the Reels. In FIGS. 1 and 2, the player uses the Spin button 114 to randomly rearrange the symbols displayed in the 15 symbol positions 126-154 of the 3-row by 5-column symbol matrix 170. The slot reels 156-164 spin, randomly stop, and display the symbol positions 126-154. Alternatively, any size symbol matrix may be used and any method may be used to rearrange symbols in the symbol matrix.

Short Pay Line Awards. In FIG. 1, three “E” symbols appear in the three short pay line positions 136, 140, 144 to form a winning combination.

In FIG. 1, short pay line positions are indicated by distinctive borders to draw the player's attention to the location of a winning combination. Symbols in the short pay line positions animate to emphasize a winning combination. In addition, winning combinations are further emphasized by sound effects during formation and upon completion of the combination.

In FIG. 1, the short pay line is always active. The player's wagering decisions, such as selecting conventional pay lines or bet per conventional pay line, do not affect whether or not the short pay line is active. The short pay line is funded by approximately ten percent of the total bet placed on each spin, with awards issuing according to the following pay schedule:

| | |
|---|---|
| A—A—A | 2X total bet |
| B—B—B | 3X total bet |
| C—C—C | 5X total bet |
| D—D—D | 7X total bet |
| E—E—E | 10X total bet |
| F—F—F | 15X total bet |

In FIG. 1, the three “E” symbols appearing in the short pay line pays 10× the total bet. The select lines meter 118 shows 9 conventional pay lines selected; the Bet Per Line meter 120 shows 5 credits bet per conventional pay line; and the total bet meter 112 shows the 45 credit total bet. The game, therefore, issues a 450 credit award. The Paid meter 124 shows the 450 credit award. The Credit meter 116 shows the credit pool increase from 345 to 795 credits.

Long Pay Line Awards. In FIG. 2, six “C” symbols appear in six of the eight long pay line positions 128, 132, 138, 142, 148 and 150 to form a winning combination.

In FIG. 2, long pay line positions are indicated by distinctive borders to draw the player's attention to the location of a winning combination. Symbols in the short pay line positions animate to emphasize a winning combination. In addition, winning combinations are further emphasized by sound effects during formation and upon completion of the combination.

In FIG. 2, the long pay line is always active. The player's wagering decisions, such as selecting conventional pay lines or bet per conventional pay line, do not affect whether or not the long pay line is active. The long pay line is funded by approximately twelve percent of the total bet placed on each spin, with awards issuing according to the following pay schedule:

| | |
|---|---|
| Any 3 Same | 1X total bet |
| Any 4 Same | 5X total bet |
| Any 5 Same | 10X total bet |
| Any 6 Same | 25X total bet |
| Any 7 Same | 50X total bet |
| Any 8 Same | 100X total bet |

In FIG. 2, the six “C” symbols appearing in the long pay line pays 25× the total bet. The select lines meter 118 shows 9 conventional pay lines selected; the Bet Per Line meter 120 shows 5 credits bet per conventional pay line; and the total bet meter 112 shows the 45 credit total bet. The game, therefore, issues an 1125 credit award. The Paid meter 124 shows the 1125 credit award. The Credit meter 116 shows the credit pool increase from 345 to 1470 credits.

Conventional Line Pay & Scatter Pay Awards. In FIGS. 1 and 2, the player may also receive conventional line pay and scatter pay awards, if any, for winning combinations formed on conventional pay lines. Line pay awards issue for three or more, same, adjacent symbols, starting from the leftmost position of a pay line. Scatter pay awards issue awards for two or more, same symbols anywhere in a symbol matrix 170. In FIGS. 1 and 2, however, the final arrangement of symbols in the symbol matrix 170 do not form any winning combinations of line pay or scatter pay awards.

Following issuance of all awards, the cumulative credits are added to the player's balance of credits, if any. As long as the player has credits on the Credit meter 116, the player may continue to play the gaming machine or collect the balance of credits by pressing the Cash Out button 102. In addition, the player may press the Help button 106 to view the rules of the game.

### Alternative Embodiments of the Invention

The present invention may be modified in one or more aspects from the embodiments described above, including but not limited to the following:

The present invention allows for any number of short and/or long pay lines. For example, a game using 5-position horizontal, conventional pay lines across a 3-row by 5-column symbol matrix may use a short pay line with 3 positions, another short pay line with 4 positions, and a long pay line with 9 positions.

The present invention allows for any number of short pay line positions provided that the short pay line include fewer positions the number of columns or rows used to form conventional pay lines. For example, a game using 5-position horizontal, conventional pay lines across a 3-row by 5-column symbol matrix may use two, three and/or four position short pay positions.

The present invention allows for any number of long pay line positions provided that the long pay line include more positions the number of columns or rows used to form conventional pay lines and less than all of the available symbol positions. For example, a game using 5-position horizontal, conventional pay lines across a 3-row by 5-column symbol matrix may use from 5 to 14 long pay positions.

The present invention allows for any location of the short and/or long pay line positions in the symbol matrix. For example, a game using 5-position horizontal conventional pay lines across a 3-row by 5-column symbol matrix, may place a 3-position short pay line at the top positions of columns 2, 3 and 4.

The present invention allows for short and/or long pay line positions to change locations in the symbol matrix based upon the wager; date and/or time; player or third party input; appearance of a specific symbol or symbol combination; a specific, variable or random number of spins; and/or at random. For example, the 3-positions of a short pay line may be randomly selected at the end of each spin or free spin. In addition, some position may be fixed and other positions may change. For example, one of the positions of a 3-position short pay line may be fixed and the other 2 positions change after every 3 spins or free spins.

The present combination may issue awards for any combination symbols, including any number of same or different symbols, as defined by a pay schedule. For example, a pay schedule for a 3-position short pay line may include awards for any combination of three “A,” “B,” or “C” symbols.

The present invention allows for wild symbols to replace any other symbol to form short and/or long pay line awards. For example: “B”—“Wild”—“B” appearing in a 3-position short pay line may form a winning combination and issue an award, with the “Wild” symbol acting as a “B” symbol.

The present invention allows for short or long pay line awards of any type, including credits, free spins, award enhancements, multipliers, prizes, products, and/or services. For example: a short pay line issues an award of free spins. In addition, award types may vary between multiple short or long pay lines within the same game. For example: a short pay line issues free spins, another short pay line issues prizes, and a long pay line issues credits.

The present invention allows for short or long pay line awards of any amount of credits, free spins, award enhancements, multipliers, prizes, products, and/or services. For example: a short pay line may issue an award of 10× the bet per line. Further, award amounts may vary from symbol to symbol. For example: a short pay line award using “E” symbols may issue 10× the bet per line, “F” symbols may issue 5× the total bet, and “G” symbols may issue 3× the total bet and 3 free spins.

The present invention allows for any method of indicating a short or long pay line positions, including growing, shrinking, boxing, circling, outlining, glowing, flashing, blinking, rotating, and/or color changing the positions. For example: highlighting the positions included in a 3-position short pay line with blinking highlight boxes.

The present invention allows for any method of determining the wager placed on the short and/or long pay lines, including a fixed, variable and/or random percentage of the total bet. For example, the game may assign 12% of the total bet to a short pay line and 8% to a long pay line. In addition, the player may place a separate wager on the short and/or long pay lines. For example, the player may wager 45 credits on the conventional pay lines and an additional 45 credits on a short pay line.

The present invention allows for any method of indicating the amount wagered on the short and/or long pay lines, including text, numbers, colors, and/or sound. For example, a small number indicating the short pay line wager may be placed in the bottom right-hand corner of each short pay line position. Otherwise, the game may not display the amount wagered on the short and/or long pay lines, but instead describe the method used to determine the wager amount in a separate pay table or help screen.

The present invention allows for using the short and/or long pay lines with or without other conventional pay lines. For example, a game may use only short and/or long pay lines without any other conventional pay lines; or a game may use short and/or long pay lines with any number of conventional horizontal and/or vertical pay lines.

The present invention allows for using the short and/or long pay lines in the main slot game and/or as a bonus game. For example, a short pay line may be used as a bonus game but not during the main game. In addition, the present invention may also use different numbers of short and/or long pay lines during main game and bonus game. For example, a short pay line may be used during the main game and a long pay line used during the bonus game.

### PREAMBLE TO THE CLAIMS

The many features and advantages of the present invention are apparent from the descriptions, and figures of the preferred and alternative embodiments. The present invention, however, is not limited to these embodiments, as the invention is capable of other embodiments and of being practiced and carried out in various ways. For example, features incorporated in of one embodiment may be used in other embodiments to yield another embodiment. Additionally, features mentioned in any embodiment may be interchanged with similar features not mentioned that perform the same or similar functions. And, finally, the phraseology and terminology used to explain the embodiments are only descriptive and should not be regarded as limiting. The claims, therefore, seek to cover all features and advantages that fall within the true spirit and scope of the present invention.

We claim:

1. A method of playing a game using a symbol matrix formed by a plurality of rows intersecting with a plurality of columns comprising:
a) placing a wager;
b) randomly rearranging the plurality of symbols;
c) displaying the rearranged symbols; and
d) awarding the player based upon the appearance of pre-determined combinations of symbols appearing in “short” and/or “long” pay line positions in the symbol matrix, such that:
i. Short pay lines include fewer positions than the number of rows in games using vertically oriented pay lines and/or fewer positions than the number of columns in games using horizontally oriented pay lines.
ii. Long pay lines include more positions than the number of rows in games using vertically oriented pay lines and/or more positions than the number of columns in games using horizontally oriented pay lines.
